(19) United States
(12) Patent Application Publication
(10) Pub. No.: US 2005/0047511 A1
(43) Pub. Date: Mar. 3, 2005

(54) Data receiver and data transmission system

(75) Inventors: Shiro Dosho, Osaka (JP); Yusuke Tokunaga, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD

(21) Appl. No.: 10/914,177

(22) Filed: Aug. 10, 2004

(30) Foreign Application Priority Data
Aug. 28, 2003 (JP) 2003-304427

(51) Int. Cl. H04L 25/00

(52) U.S. Cl. 375/257

(57) ABSTRACT

A data transmitter receives a reference current from a current generator and outputs as a current signal a current obtained by multiplying the reference current by a given number in accordance with the value of transmit data. A data receiver, on the other hand, receives the current signal from the data transmitter to generate a receive signal, while receiving a reference current from the current generator to generate a reference signal which is necessary for level determination of the receive signal. In this manner, the reference currents, from which the current signal and the reference signal are respectively generated, are supplied from the current generator that is used in common by the data transmitter and the data receiver.

### CROSS-REFERENCE TO RELATED APPLICATION

This application is related to Japanese Patent Application No. 2003-304427 filed on Aug. 28, 2003, whose priority is claimed under 35 USC §119, the disclosure of which is incorporated herein by reference in its entirety.

### BACKGROUND OF THE INVENTION

The present invention relates to data transmission systems, and more particularly relates to a technique for constructing data transmission systems for performing current-mode multilevel data transmission.

Data transmission between LSIs has been conventionally performed in the following manner. FIG. 9 illustrates the configuration of a conventional data transmission system. An LSI 100, serving as a data transmitter, controls switches SW1, SW2, SW3 and SW4, as necessary, to electrically connect a current generator 101 or 102 to a signal transmit line L1 or L2 so as to output a current signal. On the other hand, an LSI 200, serving as a data receiver, passes the supplied current signal through a resistance element 201 to produce a voltage between both ends of the resistance element 201, and determines the value of the receive data based on the voltage. More specifically, a polarity determination means 202 determines the polarity of the voltage and then determines the logical value of the receive data based on that polarity. Therefore, in the data transmission system, binary data can be transmitted between the data transmitter and the data receiver by reversing the polarity of the current signal (see U.S. Pat. No. 5,694,060, for example.)

To perform multilevel data transmission by the above-described data transmission system, suitable threshold values used for making multilevel decisions on a receive signal, that is, comparison levels, have to be set in the data receiver. For instance, when quaternary data is transmitted, the receive signal level is determined by comparing the level of the receive signal and three comparison levels as shown in FIG. 10.

However, particularly when the resistance element 201 shown in FIG. 9 is included in the LSI serving as the data receiver, the resistance value of the resistance element 201 varies by about 80% to 120% due to fabrication variation or the like. Therefore, a first signal level, e g., shown in FIG. 10 also varies, such that the minimum value of the first signal level approaches the first comparison level. In this situation, if noise or the like is applied to the system, determination of the receive signal level may become impossible or the level may be determined erroneously, which may diminish the reliability of the data transmission.

### SUMMARY OF THE INVENTION

In view of the above problem, it is therefore an object of the present invention that in a data receiver and a data transmission system, a receive signal level is accurately determined without being affected by fabrication variation or other factors so as to achieve highly accurate multilevel data transmission.

To achieve the above object, an inventive data receiver for receiving data using a supplied current signal includes: a receive signal generator which has a resistance circuit and generates a receive signal from a voltage produced by passing the current signal through the resistance circuit; a reference signal generator which has a resistance circuit, receives a reference current from which the current signal is produced, and generates a reference signal from a voltage produced by passing through the resistance circuit a current generated from the reference current; and a logic determination unit for performing multilevel decisions on the receive signal generated by the receive signal generator, based on the receive signal and the reference signal generated by the reference signal generator.

In the inventive data receiver, the receive signal and the reference signal are produced from the common reference current, such that there is a correlation between the receive signal and the reference signal. Therefore, even if the receive signal level varies, the reference signal level also changes according to that variation, thereby allowing an accurate determination of the receive signal level.

In the data receiver, the receive signal generator preferably has an intermediate potential stabilizing circuit for keeping an intermediate potential of the resistance circuit in the receive signal generator constant.

Then, variation in the receive signal level is controlled to be within a predetermined level range with respect to the intermediate potential, so that an input level in the logic determination unit that receives the receive signal is set more easily, thereby facilitating the design of the logic determination unit.

Specifically, the intermediate potential stabilizing circuit adjusts a voltage of the resistance circuit in accordance with variation of the intermediate potential so that the intermediate potential is set to a predetermined value.

Preferably, the receive signal generator has a negative resistance circuit which is parallel-connected to the intermediate potential stabilizing circuit and supplies a negative output resistance value.

Then, the interposed intermediate potential stabilizing circuit compensates for a deviation of the output resistance value of the receive signal generator from the actual resistance value, that is, the output resistance value of the resistance circuit. This enables the receive signal generator to generate a more accurate receive signal.

In the data receiver, an intermediate potential of the resistance circuit in the receive signal generator and an intermediate potential of the resistance circuit in the reference signal generator are preferably set to an identical potential.

Then, even if the receive signal varies due to effects of noise or the like, the reference signal also varies correspondingly, which allows data transmission with excellent noise-resistant characteristics.

In order to achieve the above object, an inventive data transmission system for performing data transmission using a current signal between a data transmitter and a data receiver includes: a current generator for generating reference currents, which are equally biased. The data transmitter receives one of the reference currents from the current generator, multiplies the reference current by a given number in accordance with a value of transmit data, and outputs a current obtained by the multiplication as the current signal. The data receiver has: a receive signal generator which has a resistance circuit, receives the current signal from the data transmitter, and generates a receive signal from a voltage produced by passing the current signal through the resistance circuit; a reference signal generator which has a resistance circuit, receives another one of the reference currents from the current generator, and generates a reference signal from a voltage produced by passing through the resistance circuit a current generated from the reference current; and a logic determination unit for performing multilevel decisions on the receive signal generated by the receive signal generator, based on the receive signal and the reference signal generated by the reference signal generator.

Then, the reference current which is supplied to the data transmitter and from which the current signal is generated, and the reference current which is given to the data receiver and from which the reference signal is generated are produced by the common current generator. The receive signal and the reference signal are therefore correlated with each other. Accordingly, even if the receive signal level varies, the reference signal level also changes in accordance with that variation, which allows an accurate determination of the receive signal level.

The current generator is preferably provided to either the data transmitter or the data receiver.

Preferably, the data transmitter and the data receiver perform data transmission via two lines, and the current signal flows from the data transmitter to the data receiver via one of the two lines and flows back to the data transmitter from the data receiver via the other line.

Then, a buffer for absorbing the current signal does not have to be provided in the data receiver. Therefore, the power consumption and circuit size of the data receiver are reduced.

More specifically, in the data transmission system, the data transmitter includes a plurality of current switch circuits which correspond to bits of the transmit data. Each of the current switch circuits outputs a current, whose magnitude is determined in accordance with the bit that corresponds to the current switch circuit, and whose polarity is switched based on the logical value of that corresponding bit. The current signal is the sum of the currents output from the respective current switch circuits.

As described above, according to the present invention, highly accurate multilevel data transmission which is not affected by fabrication variation or other factors is achieved in a current-mode data transmission system.

### BRIEF DESCRIPTION OF THE DRAWINGS

FIG. 1 illustrates the configuration of a data transmission system in accordance with a first embodiment of the present invention.

FIG. 2 illustrates the circuit configuration of a current generator shown in FIG. 1.

FIG. 3 illustrates the circuit configuration of a current multiplication circuit shown in FIG. 1.

FIG. 4 illustrates the circuit configuration of a transmit circuit shown in FIG. 1.

FIG. 5 illustrates the circuit configuration of a receive circuit shown in FIG. 1.

FIG. 6 illustrates the circuit configuration of a logic determination unit shown in FIG. 5.

FIG. 7 illustrates the configuration of a data transmission system in accordance with a second embodiment of the present invention.

FIG. 8 illustrates an exemplary application of the present invention.

FIG. 9 illustrates the configuration of a conventional data transmission system.

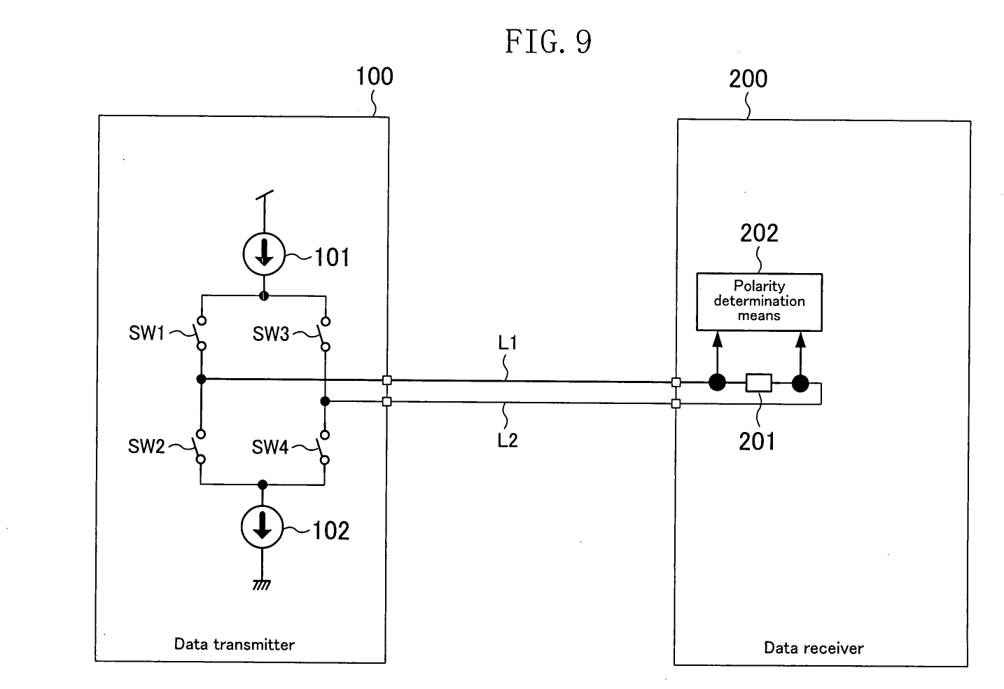

FIG. 10 illustrates relationship between receive signal levels and threshold value levels in multilevel data transmission.

### DESCRIPTION OF THE PREFERRED EMBODIMENTS

Hereinafter, preferred embodiments of the present invention will be described with reference to the accompanying drawings.

(First Embodiment)

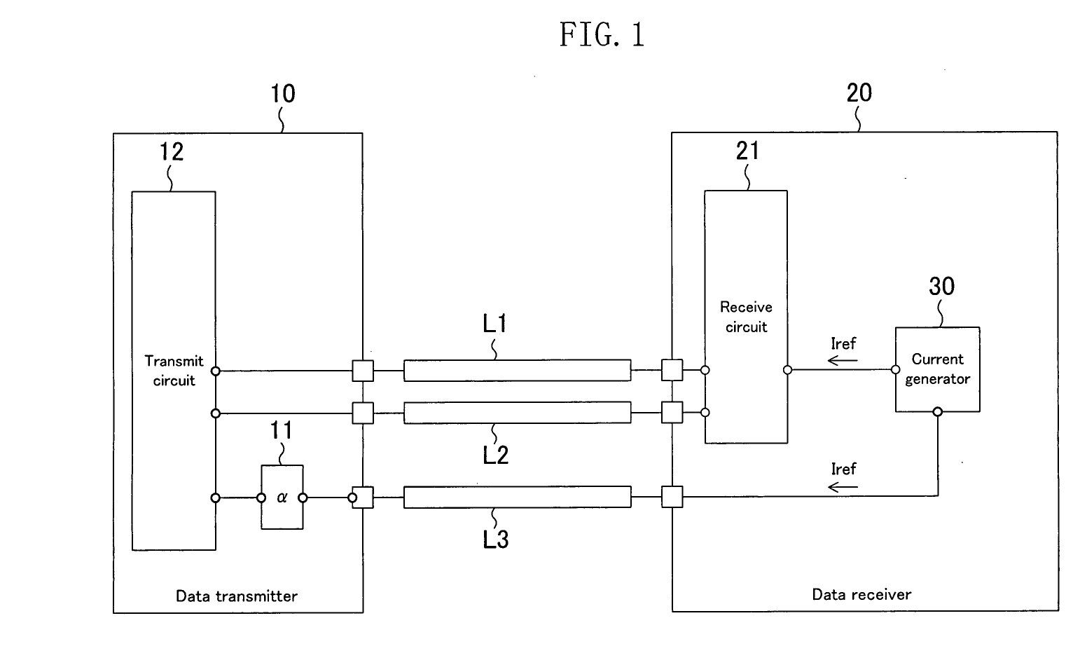

FIG. 1 illustrates the configuration of a data transmission system in accordance with a first embodiment of the present invention. The data transmission system of this embodiment includes a data transmitter 10 and a data receiver 20. The data transmitter 10 outputs via a signal transmit line L1 or L2 a current signal produced based on multilevel data and the data receiver 20 receives the multilevel data. Each of the data transmitter 10, and the data receiver 20 may be composed of a single chip LSI. The data transmission system of this embodiment further includes a current generator 30 for generating reference currents Iref. The current generator 30 is provided on the data receiver 20.

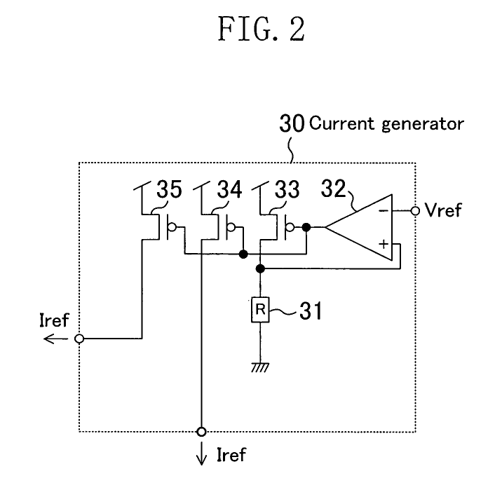

FIG. 2 illustrates the specific circuit configuration of the current generator 30. The current generator 30 receives a reference voltage Vref and outputs the reference currents Iref. In the current generator 30, one end of a resistance element 31 (resistance value R) is connected to a noninverting input terminal of an operational amplifier 32, while the other end thereof is grounded. When the reference voltage Vref is supplied to the noninverting input terminal of the operational amplifier 32, the one end of the resistance element 31 has the voltage Vref due to a so-called imaginary short. As a result, a current, which is determined by Vref/R, flows through a PMOS transistor 33 that is connected in series to the resistance element 31. In the current generator 30, the gate electrodes of the respective PMOS transistors 33, 34 and 35 are connected to each other and biased by the output from the operational amplifier 32. Therefore, when the device characteristics of the PMOS transistors 33 through 35 are equal to each other, currents equivalent to the current passing through the PMOS transistor 33 respectively flow through the PMOS transistors 34 and 35 and are output as the reference currents Iref.

Referring back to FIG. 1, the data transmitter 10 includes a current multiplication circuit 11 for multiplying (by α) the reference current Iref supplied through a biased-current transmit line L3, and a transmit circuit 12 for outputting multilevel data as a current signal.

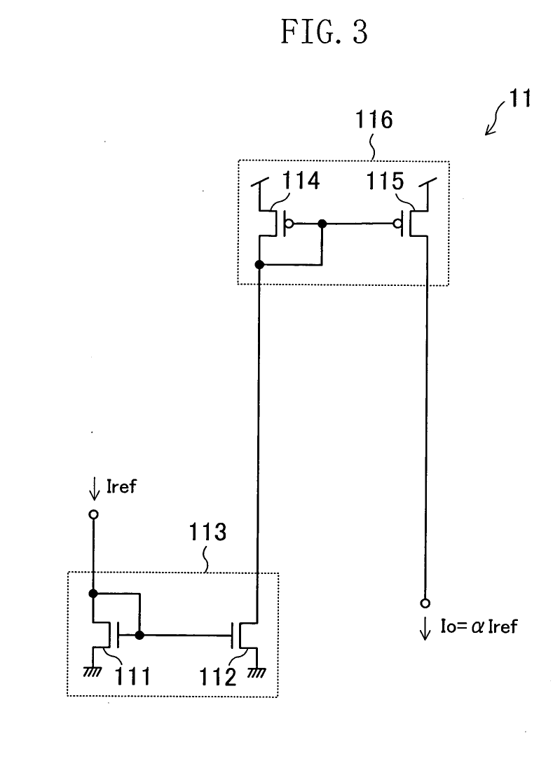

FIG. 3 illustrates the specific circuit configuration of the current multiplication circuit 11. The current multiplication circuit 11 includes current mirror circuits 113 and 116. The current mirror circuit 113 includes NMOS transistors 111 and 112, while the current mirror circuit 116 includes PMOS transistors 114 and 115. The current multiplication circuit 11 outputs a current Io, which is equal to α times the reference current Iref.

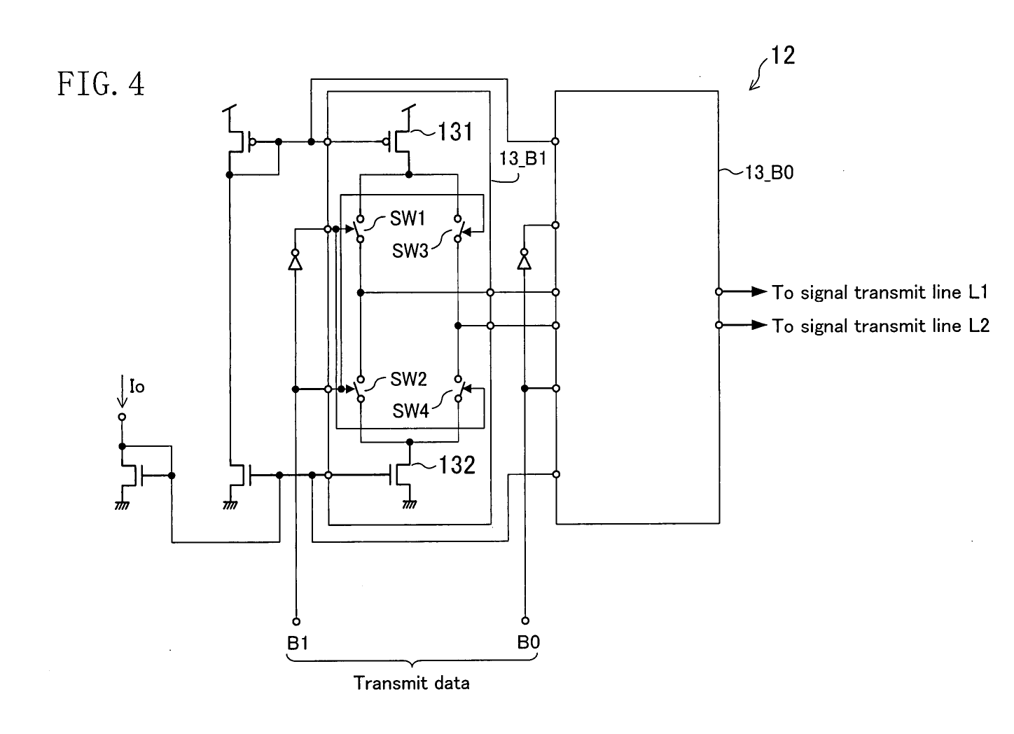

FIG. 4 illustrates the specific circuit configuration of the transmit circuit 12. The transmit circuit 12 includes a plurality of current switch circuits 13 to correspond to the bits of transmit data. The transmit circuit 12 receives the current Io generated by the current multiplication circuit 11, multiplies the current Io by a given number in accordance with the value of the transmit data, and outputs a current signal to the signal transmit line L1 or L2. It should be noted that this embodiment will be described based on the assumption that the transmit data has two bits (B0 and B1).

Each current switch circuit 13 includes a PMOS transistor 131 and an NMOS transistor 132, serving as current generators, and switches SW1, SW2, SW3 and SW4. The current switch circuit 13 controls the switches SW1 through SW4 appropriately in accordance with the logical value of the corresponding bit of the transmit data so as to change the direction of its output current. The output currents of the respective current switch circuits 13 are summed together and the sum is output to the signal transmit line L1 or L2.

Assume for example that a current value supplied from the current generators in the current switch circuit 13_B1 that corresponds to the bit B1 is 2Io/3 and a current value supplied from the current generators in the current switch circuit 13_B0 that corresponds to the bit B0 is Io/3. In this case, if the transmit data (B1, B0) is (“0”, “0”), the output current from the current switch circuit 13_B1 will be 2Io/3, and the output current from the current switch circuit 13_B0 will be Io/3, such that the output current from the transmit circuit 12 will be Io. Similarly, if the transmit data (B1, B0) is (“0”, “1”), the output current from the current switch circuit 13_B1 will be 2Io/3, and the output current from the current switch circuit 13_B0 will be—Io/3, such that the output current from the transmit circuit 12 will be Io/3. If the transmit data (B1, B0) is (“1”, “0”), the output current from the current switch circuit 13_B1 will be—2Io/3, and the output current from the current switch circuit 13_B0 will be Io/3, such that the output current from the transmit circuit 12 will be—Io/3. And if the transmit data (B1, B0) is (“1”, “1”), the output current from the current switch circuit 13_B1 will be—2Io/3, and the output current from the current switch circuit 13_B0 will be—Io/3, such that the output current from the transmit circuit 12 will be—Io. In this manner, the multilevel data (quaternary data in this case) is output as a current signal.

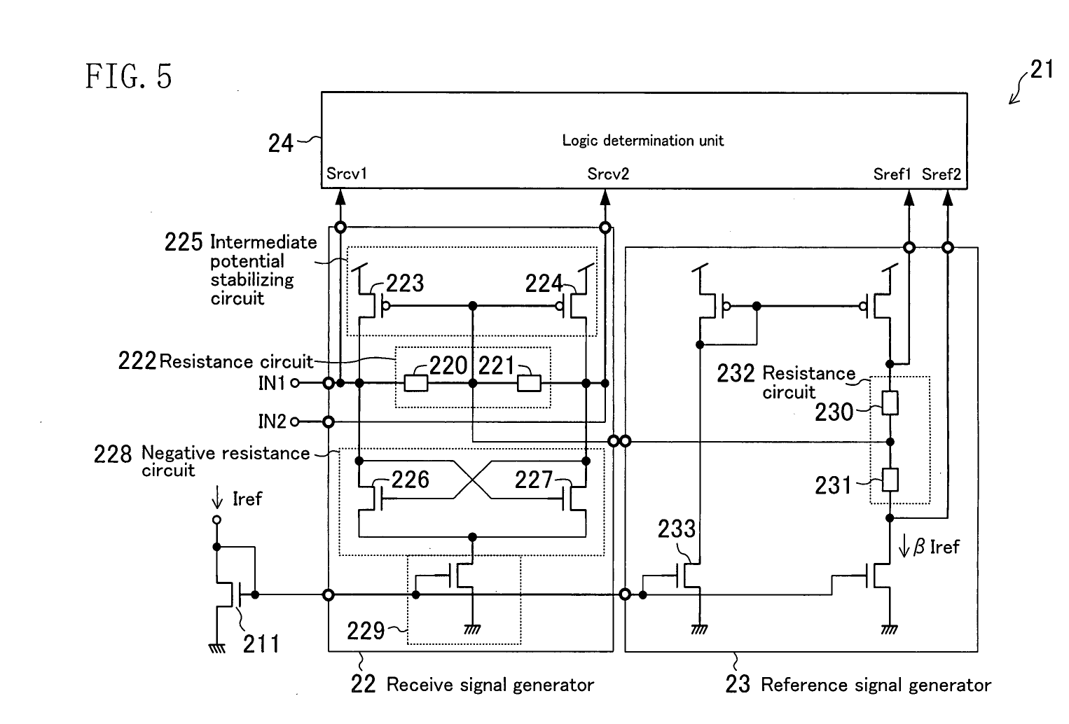

Referring back to FIG. 1, the data receiver 20 includes a receive circuit 21. FIG. 5 illustrates the specific circuit configuration of the receive circuit 21. The receive circuit 21 includes: a receive signal generator 22 which generates a receive signal, which consists of signals Srcv1 and Srcv2, from a supplied current signal; a reference signal generator 23 which receives the reference current Iref from the current generator 30 to generate comparison levels used for multilevel decisions on receive data, that is, to generate a reference signal, which consists of signals Sref1 and Sref2; and a logic determination unit 24 which performs the multilevel decisions on the receive data.

The receive signal generator 22 includes a resistance circuit 222 having resistance elements 220 and 221 that are connected in series with each other. The resistance circuit 222 is electrically connected between the signal transmit lines L1 and L2. Therefore, a current signal supplied via the signal transmit line L1 or L2 to an input terminal IN1 or IN2 flows through the resistance circuit 222 to flow back to the data transmitter 10 via the input terminal IN2 or IN1 and then via the transmit line L2 or L1. When the current signal passes through the resistance circuit 222, a voltage is produced between both ends of the resistance circuit 222. Potentials of both ends of the resistance circuit 222 respectively become the signals Srcv1 and Srcv2.

The receive signal generator 22 further includes an intermediate potential stabilizing circuit 225, a negative resistance circuit 228 and a current generator 229. The intermediate potential stabilizing circuit 225, which includes two PMOS transistors 223 and 224, receives a potential (an intermediate potential) at the connecting point of the resistance elements 220 and 221 in the resistance circuit 222 to control the potentials at both ends of the resistance circuit 222. The negative resistance circuit 228 includes two NMOS transistors 226 and 227 and is parallel-connected to the intermediate potential stabilizing circuit 225. The current generator 229 supplies current to the intermediate potential stabilizing circuit 225 and the negative resistance circuit 228.

In the intermediate potential stabilizing circuit 225, the gates of the respective PMOS transistors 223 and 224 are connected to each other so that the intermediate potential of the resistance circuit 222 is applied to those gates. A predetermined potential is supplied to the sources of the respective PMOS transistors 223 and 224, while the drains thereof are respectively connected to both ends of the resistance circuit 222. In this structure, as the intermediate potential increases, the current efficiency of the PMOS transistors 223 and 224 improves, while their drain potential decreases. On the other hand, as the intermediate potential decreases, the current efficiency of the PMOS transistors 223 and 224 degrades, while their drain potential rises. In other words, the intermediate potential stabilizing circuit 225 supplies to both ends of the resistance circuit 222 a potential that changes in the opposite direction to that in which the intermediate potential of the resistance circuit 222 changes. This stabilizes the intermediate potential of the resistance circuit 222, that is, the average value of the voltages at both ends.

When the current efficiency of the PMOS transistors 223 and 224 in the intermediate potential stabilizing circuit 225 is gm, an output resistance value from the intermediate potential stabilizing circuit 225 will be about 1/gm. More specifically, an output resistance value produced from the receive signal generator 22, measured at the input terminals IN1 and IN2, is a value resulting from the parallel connection of the resistance circuit 222 and the intermediate potential stabilizing circuit 225 and deviates from the actual resistance value of the resistance circuit 222. In view of this, the negative resistance circuit 228 is provided for canceling the resistance value of the intermediate potential stabilizing circuit 225.

In the negative resistance circuit 228, the gate of the NMOS transistor 226 is connected to the drain of the NMOS transistor 227, and the gate of the NMOS transistor 227 is connected to the drain of the NMOS transistor 226. The output resistance value of the intermediate potential stabilizing circuit 225 is cancelled by adjusting the device characteristics of the NMOS transistors 226 and 227 in such a manner that the resistance value of the negative resistance circuit 228, measured at the input terminals IN1 and IN2, becomes—1/gm. Accordingly, the output resistance value of the receive signal generator 22, measured at the input terminals IN1 and IN2, is considered equal to the output resistance value of the resistance circuit 222.

On the other hand, the reference signal generator 23 includes a resistance circuit 232 having serial-connected resistance elements 230 and 231. The reference signal generator 23 generates therein a current that is equal to β times the reference current Iref and then passes that current through the resistance circuit 232. Potentials produced at both ends of the resistance circuit 232 at this time respectively become the signals Sref1 and Sref2.

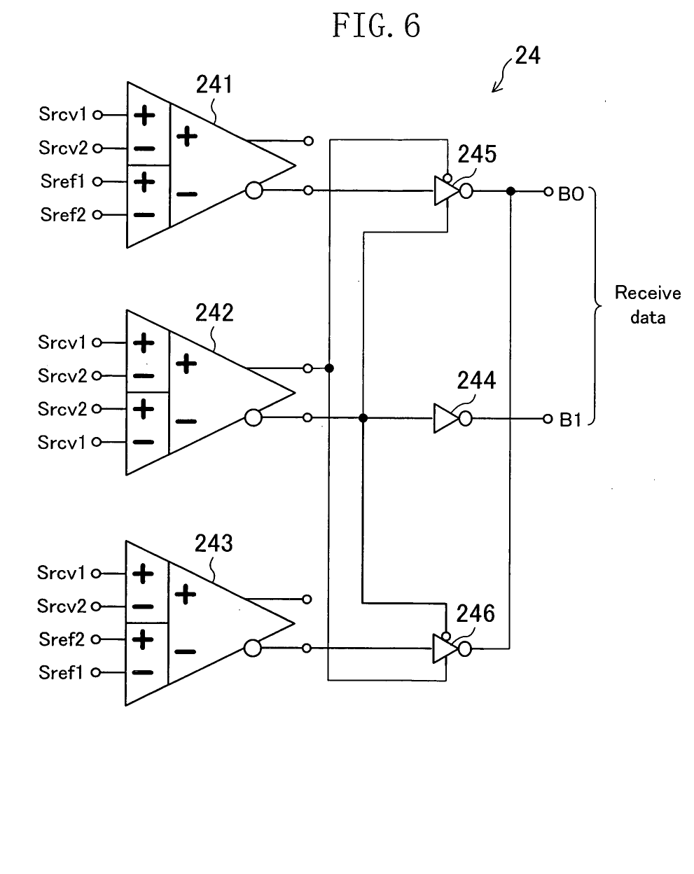

The logic determination unit 24 receives the signals Srcv1 and Srcv2 and the signals Sref1 and Sref2 to perform multilevel decisions on the receive data. FIG. 6 illustrates the specific circuit configuration of the logic determination unit 24. The logic determination unit 24 includes three differential comparators 241, 242 and 243. Each of the differential comparators 241 through 243 receives a differential voltage between the signals Srcv1 and Srcv2 as a first input.

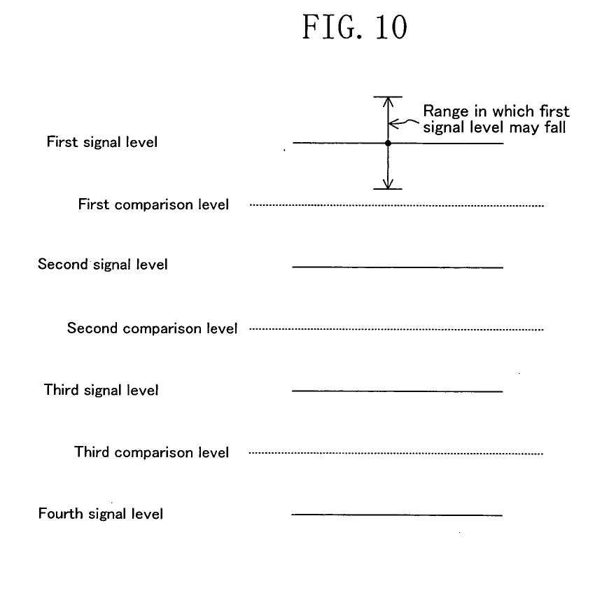

The differential comparator 241 receives a differential voltage between the signals Sref1 and Sref2 as a second input. This differential voltage is equal to the first comparison level shown in FIG. 10.

The differential comparator 242 receives as a second input a differential voltage between the signals Srcv2 and Srcv1, that is, a differential voltage which is opposite in polarity to the first input. This differential voltage is equal to the second comparison level shown in FIG. 10 and the level thereof is “0”.

The differential comparator 243 receives as a second input a differential voltage between the signals Sref2 and Sref1, that is, a differential voltage which is opposite in polarity to the second input to the differential comparator 241. This differential voltage is equal to the third comparison level shown in FIG. 10.

In the logic determination unit 24, an inverter 244 inverts inverting output from the differential comparator 242, and the obtained output will be the higher-order bit B1 of receive data. The lower-order bit B0 of the receive data is obtained by inversion of inverting outputs of the respective differential comparators 241 and 243 by signal-inverting circuits with tri-state output (hereinafter referred to as “tri-state circuits”) 245 and 246. The tri-state circuits 245 and 246 are controlled by the noninverting output and inverting output from the differential comparator 242. When the higher-order bit B1 is “1”, output from the tri-state circuit 246 is put to a high impedance state, while output from the tri-state circuit 245 becomes the lower-order bit B0. On the other hand, when the higher-order bit B1 is “0”, the output from the tri-state circuit 245 is put to a high impedance state, while the output from the tri-state circuit 246 becomes the lower-order bit B0.

With the above configuration, the data transmitter 10 outputs a current (one of four currents, αIref, αIref/3,—αIref/3 and—αIref), which is obtained by multiplying the current αIref, which is α times the reference current Iref, by a predetermined number according to a transmit data value. In this embodiment, when the resistance value of the resistance circuit 222 in the receive signal generator 22 in the data receiver 20 is Rin, the differential voltage between the signals Srcv1 and Srcv2 is, e.g., RinαIref, which is a value obtained by multiplying a received current signal, e.g., αIref, by the resistance value Rin. On the other hand, the reference signal generator 23 also generates the signals Sref1 and Sref2 based on the current βIref, which is obtained by multiplying the reference current Iref by β. When the resistance value of the resistance circuit 232 is Rref, the differential voltage between the signals Sref1 and Sref2 is RrefβIref. Thus, the ratio accuracy of the receive signal level and the comparison level is αRin/βRref.

The resistance circuits 222 and 232 are both formed on the data receiver 20. This means that they are present in the same LS1 and the ratio accuracy of Rin and Rref is thus very high (the error is about 1%). On the other hand, α is determined by the aspect ratio (gate width/gate length) between the NMOS transistors 111 and 112 that form the current mirror circuit 113 and the aspect ratio between the PMOS transistors 114 and 115 that form the current mirror circuit 116 shown in FIG. 3. Since LS1 processing accuracy is generally very high, the accuracy of α is also very high. Similarly, β is determined by the aspect ratio between the NMOS transistors 211 and 233 shown in FIG. 5, and the accuracy thereof is very high. The ratio accuracy of α and β is thus also very high. Accordingly, in the data transmission system of this embodiment, the ratio accuracy αRin/βRref of the receive signal level and the comparison level is very high.

As described above, the ratio accuracy of the receive signal level and the comparison level is very high in this embodiment. More specifically, even if there is variation in the receive signal level due to fabrication variation or the like caused in the data receiver 20, the comparison level is determined in accordance with that variation, permitting accurate multilevel decisions on the receive signal.

Moreover, as shown in FIG. 5, the connection point of the resistance elements 220 and 221 in the resistance circuit 222 is connected with the connection point of the resistance elements 230 and 231 in the resistance circuit 232. In other words, the intermediate potential of the resistance circuit 222 and the intermediate potential of the resistance circuit 232 are set to the same potential. Thus, even if the receive signal level varies due to effects of nose or the like, the reference signal level varies correspondingly, thereby enabling accurate multilevel decisions on the receive signal.

It should be noted that the intermediate potential of the resistance circuit 222 and the intermediate potential of the resistance circuit 232 do not have to be set to the same potential.

Also, in the current generator 30, the device characteristics of the PMOS transistors 33 through 35 do not necessarily have to be set equal to each other. In other words, the reference current Iref given to the data receiver 10 does not have to be equal to the reference current Iref supplied to the data transmitter 20. Even if reference currents of different magnitudes are supplied respectively to the data receiver 10 and the data transmitter 20, effects similar to those described above are achieved, so long as those reference currents are generated by the current generator 30.

Furthermore, the negative resistance circuit 228 may be omitted in the receive signal generator 22. The intermediate potential stabilizing circuit 225 and the current generator 229 may also be omitted. In that case, the resistance circuit 222 may be formed of a single resistance element. The resistance circuit 232 may also be formed of a single resistance element.

In this embodiment, a current signal output from the data receiver 10 flows via one of the signal transmit lines L1 and L2 through the data receiver 20 and flows back to the data transmitter 10 via the other signal transmit line. However, the present invention is not limited to this. For instance, a buffer may be provided in the data receiver 20 to absorb the current signal, which allows the data transmission to be performed using a single line. Such a configuration does not reduce the above mentioned effects at all.

Furthermore, although in this embodiment the data to be transmitted is quaternary (2-bit) data, the present invention is not limited to this. In the present invention, octal (3-bit) or higher multilevel data is accurately transmitted.

(Second Embodiment)

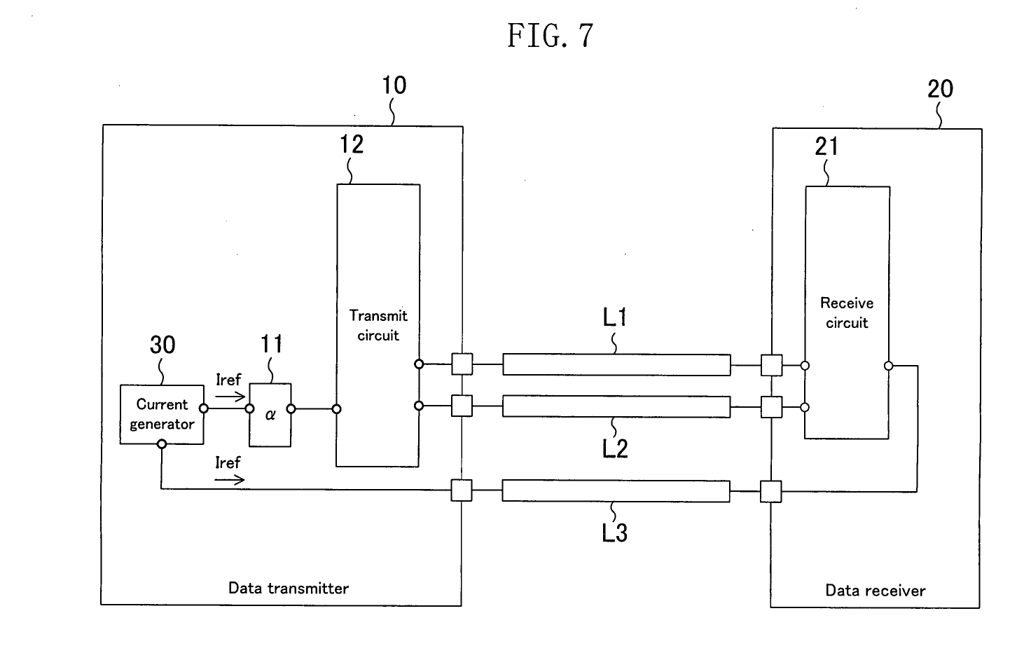

FIG. 7 illustrates the configuration of a data transmission system in accordance with a second embodiment of the present invention. The data transmission system of this embodiment differs from the data transmission system of the first embodiment in that a current generator 30 is provided not on a data receiver 20 but on a data transmitter 10. The components other than this are the same as those in the first embodiment, so the descriptions thereof will be omitted herein.

Even if the current generator 30 is formed on the data transmitter 10 as in this embodiment, effects similar to those of the first embodiment are attained. In other words, the current generator 30 may be provided anywhere in the data transmission system of this invention. The current generator 30 may be provided anywhere other than on the data transmitter 10 and the data receiver 20.

Although in the first and second embodiments, the data transmitter 10 and the data receiver 20 are formed using PMOS and NMOS transistors, the present invention is not limited to this. Effects similar to those mentioned above are achieved, even if the data transmitter 10 and the data receiver 20 are formed using other kinds of transistors.

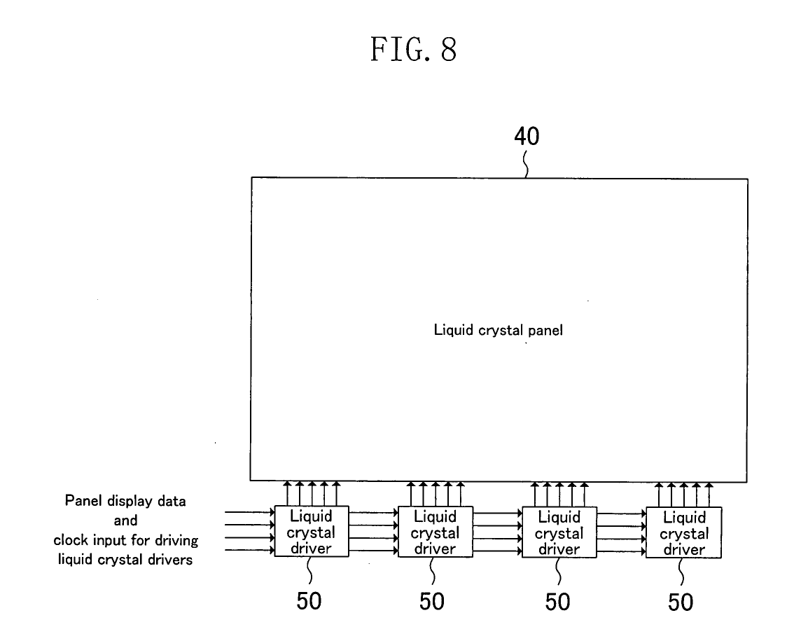

As described above, the data transmission systems of the present invention accurately perform multilevel data transmission using a current signal, and therefore effectively function particularly as a system in which short-distance, current-mode data transmission/reception has to be performed between LSIs. For example, a plurality of source driver LSIs 50 for driving a liquid crystal panel 40 are generally necessary for the single liquid crystal panel 40 as shown in FIG. 8. The source driver LSIs 50 are typically mounted along the lower portion (in FIG. 8) of the liquid crystal panel 40. In this case, when data is transmitted from the left as shown in FIG. 8, the LSIs 50 have to receive the transmitted data from the LSI 50 mounted on their left side. Therefore, the data transmission systems of the present invention are particularly effective for this type of liquid crystal panel system.

1. A data receiver for receiving data using a supplied current signal, the data receiver comprising:
a receive signal generator which has a resistance circuit and generates a receive signal from a voltage produced by passing the current signal through the resistance circuit;
a reference signal generator which has a resistance circuit, receives a reference current from which the current signal is produced, and generates a reference signal from a voltage produced by passing through the resistance circuit a current generated from the reference current; and
a logic determination unit for performing multilevel decisions on the receive signal generated by the receive signal generator, based on the receive signal and the reference signal generated by the reference signal generator.

2. The data receiver of claim 1, wherein the receive signal generator has an intermediate potential stabilizing circuit for keeping an intermediate potential of the resistance circuit in the receive signal generator constant.

3. The data receiver of claim 2, wherein the intermediate potential stabilizing circuit adjusts a voltage of the resistance circuit in accordance with variation of the intermediate potential so that the intermediate potential is set to a predetermined value.

4. The data receiver of claim 3, wherein the receive signal generator has a negative resistance circuit which is parallel-connected to the intermediate potential stabilizing circuit and supplies a negative output resistance value.

5. The data receiver of claim 1, wherein an intermediate potential of the resistance circuit in the receive signal generator and an intermediate potential of the resistance circuit in the reference signal generator are set to an identical potential.

6. A data transmission system for performing data transmission using a current signal between a data transmitter and a data receiver, the system comprising:
a current generator for generating reference currents, which are equally biased,
wherein the data transmitter receives one of the reference currents from the current generator, multiplies the reference current by a given number in accordance with a value of transmit data, and outputs a current obtained by the multiplication as the current signal; and
the data receiver has:
a receive signal generator which has a resistance circuit, receives the current signal from the data transmitter, and generates a receive signal from a voltage produced by passing the current signal through the resistance circuit;
a reference signal generator which has a resistance circuit, receives another one of the reference currents from the current generator, and generates a reference signal from a voltage produced by passing through the resistance circuit a current generated from the reference current; and
a logic determination unit for performing multilevel decisions on the receive signal generated by the receive signal generator, based on the receive signal and the reference signal generated by the reference signal generator.

7. The data transmission system of claim 6, wherein the current generator is provided to either the data transmitter or the data receiver.

8. The data transmission system of claim 6, wherein the data transmitter and the data receiver perform data transmission via two lines, and
the current signal flows from the data transmitter to the data receiver via one of the two lines and flows back to the data transmitter from the data receiver via the other line.

9. The data transmission system of claim 6, wherein the data transmitter includes a plurality of current switch circuits which correspond to bits of the transmit data;
each of the current switch circuits outputs a current, whose magnitude is determined in accordance with the bit that corresponds to the current switch circuit, and whose polarity is switched based on the logical value of that corresponding bit; and
the current signal is the sum of the currents output from the respective current switch circuits.
